(19) United States
(12) Patent Application Publication
(10) Pub. No.: US 2020/0068929 A1
(43) Pub. Date: Mar. 5, 2020

(54) LOW GLYCEMIC SUGAR PRODUCTION METHOD

(71) Applicant: Sweet Sense Inc., Bethesda, MD (US)

(72) Inventors: Alvaro Patricio Martinez, Nuevo Laredo (MX); Rene Garcia Rangel, Tijuana (MX); Brett Steven Johnson, Tijuana (MX); Jesus Manuel Lopez Lopez, Playas De Tijuana (MX)

(21) Appl. No.: 16/555,351

(22) Filed: Aug. 29, 2019

Related U.S. Application Data
(60) Provisional application No. 62/725,011, filed on Aug. 30, 2018.

(51) Int. Cl. A23L 5/20; A23L 5/10; A23L 33/20

(52) U.S. Cl. CPC A23L 5/21; A23L 33/20; A23L 5/13

(57) ABSTRACT

Embodiments of the invention provide processes or methods of forming a sugar by exposing a starting mixture of ingredients including water, sucrose and inositol to a heat source until the ingredients in the mixture are evenly distributed in a product mixture. The product mixture is subsequently removed from the heat source, cooled and hardened. The hardened product mixture is crushed and pulverized to form a modified sugar with a glycemic index that is lower than at least one of the ingredients of the starting mixture of ingredients.

### RELATED APPLICATIONS

This application claims the benefit of and priority to U.S. Provisional Application No. 62/725,011, filed Aug. 30, 2018, entitled “LOW GLYCEMIC NON-HYGROSCOPIC SUGAR PRODUCTION METHOD”, the entire contents of which are incorporated herein by reference.

### BACKGROUND

Methods to make hard candy are known to those skilled in the art by using steam, electric, or other sources in continuous flow vacuum, simplex, micro film, sucroliner or open fire cookers that heat mixtures of sucrose, other sugars, water, and/or sugar alcohols, and/or other additives to their amorphous states. Various concentrations of ingredients are often used to finely adjust the taste, texture, and color.

Candy formulations that incorporate low glycemic sugars suitable for consumption by those with diabetes are more challenging to manufacture into shelf-stable candy or other products that have sufficient malleability for processing.

### SUMMARY OF THE INVENTION

Some embodiments include a cooking process comprising exposing a starting mixture of ingredients including water, sucrose and inositol to a heat source until the ingredients in the mixture are evenly distributed in a product mixture. Further, some embodiments include removing the product mixture from the heat source, and cooling and hardening the product mixture. Further, some embodiments include crushing and pulverizing the cooled and hardened product mixture to form a modified sugar with a glycemic index that is lower than at least one of the ingredients of the mixture of ingredients.

In some embodiments, the sugar is screened into grains. In some embodiments, the product mixture is formed under continuous flow vacuum. In some further embodiments, the product mixture is formed under a batch or static vacuum. In other embodiments, the product mixture is formed under an open-fire kettle.

In some embodiments, the starting mixture of ingredients further includes invert sugar. In some embodiments, the starting mixture of ingredients further includes corn syrup. In other embodiments, the starting mixture of ingredients further includes rice syrup. In some further embodiments, the starting mixture of ingredients further includes at least one filler. In some embodiments, at least one filler is silicon dioxide (SiO₂).

In some embodiments, the starting mixture of ingredients comprises 70% by dry weight of sucrose, and 30% by dry weight of inositol. In other embodiments, the starting mixture of ingredients comprises 60% by dry weight of sucrose, and 40% by dry weight of inositol. In some further embodiments, the starting mixture of ingredients comprises 58% by dry weight of sucrose, and 30% by dry weight of inositol, and 12% dry weight of corn syrup solids or rice syrup solids. In some further embodiments, the starting mixture can optionally include not more than 20% by dry weight corn syrup solids, and/or not more than 20% by dry weight of rice syrup solids. In some embodiments, at least a portion of the corn syrup solids or rice syrup solids can include tapioca and/or agave-based syrup solids, partial solids, and/or liquids. In some embodiments, the starting mixture is heated to not less than 250 degrees Fahrenheit and not more than 320 degrees Fahrenheit.

Some embodiments include a method of preparing a mixture by mixing water, 58% or more by dry weight of sucrose, and 30% or more by dry weight of inositol. Some further embodiments include heating the starting mixture to form a homogenous product mixture, where the mixture is heated to not less than 250 degrees Fahrenheit and not more than 320 degrees Fahrenheit. Some embodiments include cooling the homogenous product mixture, where the homogenous product mixture comprises a modified sugar with a glycemic index that is lower than sucrose.

In some embodiments, the mixture further includes at least one of corn syrup solids, rice syrup solids, tapioca and/or agave-based syrup solids, partial solids, and/or liquids. In other embodiments, the mixture heating of the mixture occurs in an open fire kettle or under vacuum.

Some embodiments of the method further comprise crushing, pulverizing, and screening the cooled and hardened product mixture to form granular modified sugar with a glycemic index that is lower than the mixture prior to heating.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

Some embodiments of the invention include methods to produce low glycemic sugar suitable for consumption by those with diabetes, or non-diabetics seeking to reduce their conventional sugar intake. For example, some embodiments of the invention include a method to produce a low glycemic sugar product comprising heating a mixture of water, not more than about 90% and not less than about 50% by dry weight of sucrose, and not more than about 50% and not less than about 5% by dry weight of inositol (cyclohexane-1,2,3,4,5,6-hexol), a sugar alcohol with about half the sweetness of sugar.

Some embodiments can utilize one or more food grade sugar alcohols, including, but not limited to those shown in Table 1:

TABLE 1

| Made from: | Made from: | |
|---|---|---|
| Monosaccharides | Disaccharides | |
| (glucose, fructose, | (sucrose, | Made from: |
| galactose, ribose, | lactose, | Polysaccharides |
| xylose) | maltose) | (starch, cellulose, glycogen) |
| Sorbitol** | Maltitol | Maltitol syrup |
| Mannitol** | Isomalt | Hydrogenated starch hydrolysates |
| | | Hydrogenated starch hydrolysates |
| | | (HSH) |
| Erythritol: | Lactitol | |
| Low glycemic index | | |
| without laxative | | |
| affect. | | |
| Xylitol | | |

*Inositol is structurally similar to glucose
**May require label warning statement: “Excess consumption may have a laxative effect.”

In some embodiments, the mixture can optionally include not more than 20% by dry weight corn syrup solids, and/or not more than 20% by dry weight of rice syrup solids. Some embodiments can include other syrup or syrup solids that can be substituted or used in addition to corn and rice syrup solids or used in combination. For example, some embodiments include tapioca and/or agave-based syrup solids, partial solids, and/or liquids.

In some embodiments, the mixture of sugar, syrup, water, and inositol can be heated in a continuous flow vacuum, simplex, micro film, sucroliner or open fire cooker to not less than 250 degrees Fahrenheit and not more than 320 degrees Fahrenheit until water is evaporated, mixing the amorphous mixture until the ingredients are evenly distributed.

In some embodiments, the rate of heating can impact color, and/or texture, and/or composition, and/or flavor. In some embodiments, the heating of the sugar, syrup, water and inositol mixture can begin as the ingredients are introduced to the kettle, and the mixing commences. Some embodiments include heating times that should not be less than about 2 minutes. Some further embodiments include heating times that are no longer than about 7 minutes per 105 lb batch (e.g., such as a 105 lb batch). In other embodiments, the same conditions can be used in a continuous flow process.

In some embodiments, after removing the amorphous cooked mixture from the heat source, the mixture can be placed on trays, in molds, or similar apparatus and cooled until the substance is sufficiently hardened. In some embodiments, the cooked hardened mixture can be crushed, pulverized, and screened into fine grains resulting in a low glycemic modified sugar. In some embodiments, this modified sugar can be suitable for consumption by those with diabetes, or non-diabetics seeking to reduce their conventional sugar intake.

Some further embodiments include a process for the manufacture of crushed candy approximating the size, taste, color, and texture of standard or conventional table sugar, or conventional candy produced using standard or conventional table sugar, comprising heating a mixture of water, 70% by dry weight of sucrose, and 30% by dry weight of inositol. In some embodiments, the sugar, syrup, water and inositol mixture can be heated in an open fire cooker to 300 degrees Fahrenheit, mixed until the ingredients in the mixture are evenly distributed, removed from the heat, and introduced to a cooling process (e.g., such as by being poured onto a cooling tray). In some embodiments, the mixture can be allowed to cool until hardened, crushed, pulverized, and screened to produce a low glycemic modified sugar.

Some further embodiments include a process for the manufacture of crushed candy approximating the size, taste, color, and texture of standard or conventional table sugar, or conventional candy produced using standard or conventional table sugar, comprising heating a mixture of water, 70% by dry weight of sucrose, and 30% by dry weight of inositol. In some embodiments, the sugar, syrup, inositol and water mixture can be heated in an open fire cooker to about 307 degrees Fahrenheit until the water has evaporated, mixed until the ingredients in the mixture are evenly distributed, removed from the heat, and introduced to a cooling process (e.g., such as a cooling tray). In some embodiments, the mixture can be allowed to cool until hardened, crushed, pulverized, and screened to produce a low glycemic modified sugar suitable for consumption by those with diabetes.

Some further embodiments include a process for the manufacture of crushed candy approximating the size, taste, color, and texture of standard or conventional table sugar or conventional candy produced using standard or conventional table sugar, comprising heating a mixture of water, 60% by dry weight of sucrose, and 40% by dry weight of inositol. In some embodiments, the mixture can be heated in a Simplex cooker to 273 degrees Fahrenheit, with 20 inches Hg vacuum is applied for about 1 minute until water is evaporated, and mixed until the ingredients in the mixture are evenly distributed, removed from the heat, and cooled (e.g. by being poured onto a cooling tray). In some embodiments, the mixture can be allowed to cool until hardened, crushed, pulverized, and screened to produce a low glycemic modified sugar suitable for consumption by those with diabetes, or non-diabetics seeking to reduce their conventional sugar intake.

Some further embodiments include a process for the manufacture of crushed candy approximating the size, taste, color, and texture of standard or conventional table sugar, or conventional candy produced using standard or conventional table sugar, comprising heating a mixture of water, 58% by dry weight of sucrose, and 30% by dry weight of inositol, and 12% dry weight of corn syrup solids. In some embodiments, the mixture can be heated in a Simplex cooker to 300 degrees Fahrenheit, with 5 inches Hg vacuum is applied for about 10 minutes until water is evaporated, and mixed until the ingredients in the mixture are evenly distributed, removed from the heat, and introduced to a cooling process (e.g., such as a cooling tray). In some embodiments, the mixture can be allowed to cool until hardened, crushed, pulverized, and screened to produce a low glycemic modified sugar suitable for consumption by those with diabetes, or non-diabetics seeking to reduce their conventional sugar intake.

Some further embodiments include a process for the manufacture of crushed candy approximating the size, taste, color, and texture of standard or conventional table sugar or conventional candy produced using standard or conventional table sugar, comprising heating a mixture of water, 58% by dry weight of sucrose, and 30% by dry weight of inositol, and 12% dry weight of rice syrup solids. In some embodiments, the mixture can be heated in a continuous flow vacuum cooker to 305 degrees Fahrenheit, with 25 inches Hg vacuum is applied until water is evaporated, and the heated mixture can be introduced to a cooling process and then shaped. The solid pieces can be fed into a forming machine to be cooled, crushed, pulverized, and screened.

Some further embodiments include a process for the manufacture of crushed candy approximating the size, taste, color, and texture of standard or conventional table sugar or conventional candy produced using standard or conventional table sugar, comprising heating a mixture of water, 58% by dry weight of sucrose, and 30% by dry weight of inositol, and 12% dry weight of corn syrup solids. In some embodiments, the mixture can be heated in a continuous flow vacuum cooker to 305 degrees Fahrenheit, with 25 inches Hg vacuum being applied until water has evaporated, and the heated mixture is introduced to a cooling process and then shaped. The solid pieces can be fed into a forming machine to be cooled, crushed, pulverized, and screened.

Some embodiments include one or more conventional fillers, bulking agents, and/or stabilizing agents. For example, some embodiments include additions of silicon dioxide (SiO₂).

Tables 2-4 shows compositions, processing conditions, and product descriptions for samples 1 to 19. For example, Table 2 shows compositions, Table 3 shows cooking processes, and Table 4 shows product attributes for samples 1 to 19 produced using the cooking processes in Table 3.

In some embodiments, one or more alternative cooking methods can be used, including, but not limited to open fire type kettle cooking, and/or batch vacuum cooking, and/or continuous flow vacuum cooking. For example, in some embodiments, the compositions or processes described herein can include open fire kettle cooking in which a mixture is heated with a gas fire until completion, where no vacuum or lid is used. Some other embodiments can utilize a batch vacuum cooking system, where a mixture is brought to an open boil, then the lid (or dome) is closed over the top of the kettle, and vacuum is applied to remove moisture. In some embodiments, continuous flow vacuum cooking can include a steam coil heating unit that heats a continuous flow of the mixture prior to entry into the kettle. Using this method, as soon as one batch is complete, another batch can be ready to enter the cooker, and vacuum applied. Some embodiments can include a swappable or removeable kettle that rotates into place where vacuum cooking of the next batch can begin.

| | | Mix Ratio | | | | | | Blend |
|---|---|---|---|---|---|---|---|---|
| Sample | | | | Invert | Corn | Rice | Vita Fiber | Brix |
| Run | Date | Sugar % | Insitol % | Sugar % | Syrup | Syrup | 4001T | Value |
| 1 | Nov. 8, 2017 | 70 | 30 | — | — | — | — | 76 |
| 2 | Nov. 10, 2017 | 70 | 30 | — | — | — | — | 76 |
| 3 | Nov. 16, 2017 | 70 | 30 | — | — | — | — | 76 |
| 4 | Nov. 16, 2017 | 70 | 30 | — | — | — | — | 85 |
| 5 | Nov. 17, 2017 | 62 | 30 | 8 | — | — | — | 81 |
| 6 | Nov. 21, 2017 | 63 | 30 | 7 | — | — | — | 76 |
| *7 | Nov. 23, 2017 | 70 | 30 | — | — | — | — | 85 |
| 8 | Nov. 27, 2017 | 70 | 30 | — | — | — | — | 85 |
| 9 | Nov. 28, 2017 | 60 | 40 | — | — | — | — | 85 |
| 10 | Nov. 29, 2017 | 60 | 40 | — | — | — | — | 85 |
| 11 | Nov. 30, 2017 | 60 | 40 | — | — | — | — | 85 |
| 12 | Dec. 5, 2017 | 70 | 15 | — | — | — | 15 | 85 |
| 13 | Dec. 6, 2017 | 58 | 30 | — | 12 | — | — | 76 |
| 14 | Dec. 14, 2018 | 58 | 30 | — | — | 12 | — | 76 |
| 15 | Jan. 17, 2018 | 64 | 30 | — | — | 6 | — | 76 |
| 16 | Jan. 18, 2018 | 60 | 30 | — | — | 10 | — | 76 |
| 17 | Jan. 24, 2018 | 58 | 30 | — | — | 12 | — | 76 |
| 18 | Jan. 24, 2018 | 58 | 30 | — | 12 | — | — | 76 |
| 19 | Feb. 7, 2018 | 60 | 5 | — | 35 | — | — | 76 |

Table 2: shows compositions for samples 1 to 19.

| | Cooking Process | | | |
|---|---|---|---|---|
| Sample | | Lbs | | Vacuum |
| Run | Method | Cooked | Temp F. | InHg |
| 1 | Lab | 9.5 | 300 | — |
| 2 | Lab | 7.3 | 300 | — |
| 3 | Continuous Flow Vacuum | 300 | 300 | 25 |
| 4 | Open Fire Kettle | 50 | 300 | — |
| 5 | Open Fire Kettle | 50 | 300 | — |
| 6 | Continuous Flow/NO Vacuum | 300 | 300 | — |
| *7 | Open Fire Kettle | 50 | 307 | — |
| 8 | Open Fire Kettle | 50 | 315 | — |
| 9 | Batch Vacuum | 50 | 271 | 20-7 |
| 10 | Batch Vacuum | 50 | 273 | 20-1 |
| 11 | Batch Vacuum | 50 | 282 | 20-1 |
| | | | | 20-2 |
| 12 | Open Fire Kettle | 50 | 307 | — |
| 13 | Continuous Flow Vacuum | 300 | 300 | 5-10 |
| 14 | Continuous Flow Vacuum | 300 | 305 | 25 |
| 15 | Continuous Flow Vacuum | 300 | 305 | 25 |
| 16 | Continuous Flow Vacuum | 300 | 305 | 25 |
| 17 | Continuous Flow Vacuum | 300 | 305 | 25 |
| 18 | Continuous Flow Vacuum | 300 | 305 | 25 |
| 19 | Continuous Flow Vacuum | 300 | 305 | 25 |

Table 3: shows cooking processes for samples 1 to 19.

| | Cooked product attributes | | | | |
|---|---|---|---|---|---|
| Sample | | Reduced | Minutes to | Crushed | |
| Run | Moisture % | Sugars % | Crystallize | Q 1/16″ MR | Comments |
| 1 | 0.4 | — | — | No | First lab sample cooled in a fiberglass tray, yellowish color. No |
| | | | | | further activity |
| 2 | 2.1 | — | — | Yes | Crushed product with good appearance, slightly clumpy after a |
| | | | | | week. No SiO₂ added due to availability |
| 3 | 1.26 | — | — | Yes | Bath crystallized in the cooker after first batch and started to clog |
| | | | | | the system. Batch trial aborted immediately |
| 4 | 3.92 | — | — | Yes | Crushed product with good appearance, tend to clump but still free |
| | | | | | flowing by handling, packed in a HMB bag & 0.5% SiO₂ added. |
| 5 | 4.3 | — | 18 | Yes | Batch with amber-brownish color. Free flowing/0.5% SiO₂ added |
| 6 | 2.07 | — | 16 | No | Batch with amber-brownish color. No further activity |
| *7 | 3.4 | — | 12 | Yes | Crushed product with good appearance. Free flowing. Packed in a |
| | | | | | HMB bag, 0.5% SiO₂ added |
| 8 | 2.7 | — | 8.5 | Yes | Crushed product with amber-yellowish color. Free flowing. Packed |
| | | | | | in a HMB bag, 0.5% SiO₂ added) |
| 9 | 0.4 | — | — | No | Batch crystallized in the cooker, unable to unload it |
| 10 | 3.4 | — | 16 | Yes | Batch with good color and manageability. (0.5% SiO₂ added) |
| 11 | 2.1 | — | — | No | Batch crystallized in the cooker after 2 min but still able to unload |
| | 1.3 | | | | it. Product was not crushed, because yellowish color & sticky |
| | | | | | appearance. |
| 12 | 3.5 | 7.6 | 12 | Yes | Batch with good color and manageability. Free flowing packed in a |
| | | | | | HMB bag (0.5% SiO₂ added) |
| 13 | 2.63 | 7.2 | — | Yes | Batch with good color and manageability. Free flowing packed in a |
| | | | | | HMB bag (0.5% SiO₂ added) |
| 14 | 1.1 | 6.9 | — | Yes | Batch with good color and manageability, able to be fed into a die |
| | | | | | machine to form discs. Free flowing HMB bag (0.5% SiO₂ added) |
| 15 | 1.5 | 4.1 | 5 | No | Batch mostly crystallized in the cooker pan, able to unload it. |
| 16 | 1.4 | 7.9 | 11 | No | Batch crystallized in the cold slab, unable to form discs. |
| 17 | 1.0 | 7.2 | — | Yes | Batch with good color and manageability, able to feed the forming |
| | | | | | machine to form pillows. Free flowing HMB bag (0.5% SiO₂ added) |
| 18 | 0.9 | 6.9 | — | Yes | Batch with good color and manageability, able to feed the forming |
| | | | | | machine to form pillows. Free flowing HMB bag (0.5% SiO₂ added) |
| 19 | 1.0 | 18.9 | — | Yes | Batch with good color and manageability, able to feed the forming |
| | | | | | machine to form discs. Free flowing HMB bag (0.5% SiO₂ added) |

Table 4: shows product attributes for samples 1 to 19.

It will be appreciated by those skilled in the art that while the invention has been described above in connection with particular embodiments and examples, the invention is not necessarily so limited, and that numerous other embodiments, examples, uses, modifications and departures from the embodiments are intended.

1. A cooking process comprising:
exposing a starting mixture of ingredients including water, sucrose and inositol to a heat source until the ingredients in the mixture are evenly distributed in a product mixture;
removing the product mixture from the heat source, and cooling and hardening the product mixture; and
crushing and pulverizing the cooled and hardened product mixture to form a modified sugar with a glycemic index that is lower than at least one of the ingredients of the starting mixture of ingredients.

2. The cooking process of claim 1, wherein the sugar is screened into grains.

3. The cooking process of claim 1, wherein the product mixture is formed under continuous flow vacuum.

4. The cooking process of claim 1, wherein the product mixture is formed under a batch or static vacuum.

5. The process of claim 1, wherein the product mixture is formed under an open-fire kettle.

6. The process of claim 1, wherein the starting mixture further includes invert sugar.

7. The process of claim 1, wherein the starting mixture further includes corn syrup.

8. The process of claim 1, wherein the starting mixture further includes rice syrup.

9. The process of claim 1, wherein the starting mixture further includes at least one filler.

10. The process of claim 9, wherein the at least one filler is silicon dioxide (SiO₂).

11. The process of claim 1, wherein the starting mixture of ingredients comprises 70% by dry weight of sucrose, and 30% by dry weight of inositol.

12. The process of claim 1, wherein the starting mixture of ingredients comprises 60% by dry weight of sucrose, and 40% by dry weight of inositol.

13. The process of claim 1, wherein the starting mixture of ingredients comprises 58% by dry weight of sucrose, and 30% by dry weight of inositol, and 12% dry weight of corn syrup solids or rice syrup solids.

14. The process of claim 1, wherein the starting mixture of ingredients can optionally include not more than 20% by dry weight of corn syrup solids, and/or not more than 20% by dry weight of rice syrup solids.

15. The process of claim 14, wherein at least a portion of the corn syrup solids or rice syrup solids can include tapioca and/or agave-based syrup solids, partial solids, and/or liquids.

16. The process of claim 1, wherein the starting mixture of ingredients is heated to not less than 250 degrees Fahrenheit and not more than 320 degrees Fahrenheit.

17. The method comprising:
preparing a mixture by mixing water, 58% or more by dry weight of sucrose, and 30% or more by dry weight of inositol;
heating the mixture to form a homogenous product mixture, wherein the mixture is heated to not less than 250 degrees Fahrenheit and not more than 320 degrees Fahrenheit; and
cooling the homogenous product mixture, wherein the homogenous product mixture comprises a modified sugar with a glycemic index that is lower than sucrose.

18. The method of claim 17, wherein the mixture further includes at least one of corn syrup solids, rice syrup solids, tapioca and/or agave-based syrup solids, partial solids, and/or liquids.

19. The method of claim 17, wherein the mixture heating occurs in an open fire kettle or under vacuum.

20. The method of claim 17, further comprising crushing and pulverizing, and screening the cooled and hardened product mixture to form granular modified sugar with a glycemic index that is lower than the mixture prior to heating.
